(19) United States
(12) Patent Application Publication
(10) Pub. No.: US 2025/0118473 A1
(43) Pub. Date: Apr. 10, 2025

(54) MAGNETIC COMPONENT

(71) Applicant: SAMSUNG ELECTRO-MECHANICS CO., LTD., Suwon-si (KR)

(72) Inventors: Hyo Ki HONG, Suwon-si (KR); Su Rim BAE, Suwon-si (KR); Seok Hee LEE, Suwon-si (KR); Min Seon KWON, Suwon-si (KR); Woong Sup LEE, Suwon-si (KR); Ji Min KIM, Suwon-si (KR); Joong Won PARK, Suwon-si (KR); Il Jin PARK, Suwon-si (KR); Jung Wook SEO, Suwon-si (KR); Jae Hee JU, Suwon-si (KR)

(73) Assignee: SAMSUNG ELECTRO-MECHANICS CO., LTD., Suwon-si (KR)

(21) Appl. No.: 18/888,719

(22) Filed: Sep. 18, 2024

(30) Foreign Application Priority Data
Oct. 4, 2023 (KR) 10-2023-0131879

(51) Int. Cl. H01F 3/08; H01F 1/147

(52) U.S. Cl. CPC H01F 3/08; H01F 1/14708

(57) ABSTRACT

A magnetic component includes a magnetic body, wherein the magnetic body includes a plurality of magnetic particles including an Fe-based alloy, at least a portion of magnetic particles, among the plurality of magnetic particles, include a first layer disposed on surfaces of the at least a portion of magnetic particles and a second layer disposed on a surface of the first layer, the first layer includes an Fe oxide component and has an average thickness of less than 5 nm, and the second layer includes an Si oxide component and has an average thickness of 5 nm or more.

### CROSS-REFERENCE TO RELATED APPLICATION(S)

This application claims the benefit of priority to Korean Patent Application No. 10-2023-0131879 filed on Oct. 4, 2023 in the Korean Intellectual Property Office, the disclosure of which is incorporated herein by reference in its entirety.

### TECHNICAL FIELD

The present disclosure relates to a magnetic component.

### BACKGROUND

With the miniaturization and thinning of electronic devices such as digital TVs, mobile phones, laptops, etc., the miniaturization and thinning of magnetic components applied to electronic devices are also required, and various types of magnetic components may be used to meet the requirements. An example of a magnetic component may be an inductor including a coil, and research and development on coiled type or thin film type inductors may be actively underway.

Main issues with the miniaturization and thinning of magnetic components are to achieve conventional equivalent characteristics despite such miniaturization and thinning. In order to meet such requirements, a ratio of a magnetic material in a core filled with the magnetic material should be increased, but there may be a limit to increasing the ratio due to changes in frequency characteristics or the like, depending on strength and insulation of a magnetic body.

As an example of manufacturing magnetic components, a method may be used to create a body by stacking a sheet mixed with magnetic particles, a resin, etc. on a coil and then pressing the same. Ferrite, metal, etc. may be used as such magnetic particles. When metal magnetic particles are used, it is advantageous to increase an amount of particles in terms of magnetic permeability characteristics of the magnetic component, etc., but in this case, insulation of a magnetic body may decrease, leading to eddy current loss. In addition, when an insulating layer may be coated on surfaces of the metal magnetic particles, a proportion of the metal magnetic particles in the magnetic body may be reduced, which may be disadvantageous for magnetic properties.

### SUMMARY

An aspect of the present disclosure is to improve magnetic permeability, a saturation magnetic flux value, etc. of magnetic components by forming a surface insulating layer of the magnetic particles to be thin while having excellent magnetic properties.

According to an aspect of the present disclosure, a magnetic component includes a magnetic body, wherein the magnetic body includes a plurality of magnetic particles including an Fe-based alloy, at least a portion of magnetic particles, among the plurality of magnetic particles, include a first layer disposed on surfaces of the at least a portion of magnetic particles and a second layer disposed on a surface of the first layer, the first layer includes an Fe oxide component and has an average thickness of less than 5 nm, and the second layer includes an Si oxide component and has an average thickness of 5 nm or more.

In an embodiment, the first layer may include less than 1 wt % of an Si component.

In an embodiment, the second layer may include 30% to 70 wt % of an Si component.

In an embodiment, the average thickness of the second layer may be less than 50 nm.

In an embodiment, the average thickness of the second layer may be 2 to 10 times the average thickness of the first layer.

In an embodiment, an average diameter of the plurality of magnetic particles may be 10 to 25 μm.

In an embodiment, the at least a portion of magnetic particles may further include a third layer disposed on a surface of the second layer.

In an embodiment, the third layer may include at least one functional group of an alkyl group, a carbonyl group, or urethane acrylate.

In an embodiment, the magnetic body may include at least one of oleic acid, a derivative of oleic acid, and monoamide n-allyl neopentyl ester carbonate.

In an embodiment, an average thickness of the third layer may be less than 10 nm.

In an embodiment, the Fe-based alloy may include an Fe—Si—B—C-based material.

In an embodiment, the Fe-based alloy may not include Cr, Mo, Nb, and P components.

In an embodiment, an Fe amount in the Fe-based alloy may exceed 90 wt %.

In an embodiment, an Si amount in the Fe-based alloy may be 0.1 to 5 wt %.

In an embodiment, the magnetic body may further include additional magnetic particles having an average diameter, smaller than an average diameter of the plurality of magnetic particles including the first layer and the second layer.

In an embodiment, the additional magnetic particles may include carbonyl iron particles.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a schematic transparent perspective view illustrating a magnetic component according to an embodiment of the present disclosure.

FIG. 2 is a cross-sectional view of a region of the magnetic component of FIG. 1.

FIG. 3 is an enlarged view of a region of a magnetic body in the magnetic component of FIG. 1.

FIG. 4 illustrates how a thickness of a surface insulating layer in a magnetic particle is reduced.

FIG. 5 illustrates a magnetic particle employed in a magnetic component according to a modified example.

FIG. 6 illustrates an enlarged view of a region of a magnetic body of a magnetic component according to a modified example.

FIG. 7 is a schematic transparent perspective view illustrating a magnetic component according to another embodiment of the present disclosure.

FIG. 8 is a schematic exploded perspective view of the magnetic component of FIG. 7.

FIG. 9 is a cross-sectional view of a region of the magnetic component of FIG. 7.

### DETAILED DESCRIPTION

Hereinafter, embodiments of the present disclosure will be described with reference to specific embodiments and the accompanying drawings. However, an embodiment of the present disclosure may be modified to have various other forms, and the scope of the present disclosure is not limited to embodiments described below. Further, embodiments of the present disclosure may be provided in order to more completely explain the present disclosure to those skilled in the art. Accordingly, shapes and sizes of components in the drawings may be exaggerated for clearer description, and components indicated by the same reference numerals in the drawings may be the same elements.

Various types of electronic components may be used in electronic devices, and various types of coil components may be appropriately used among these electronic components for purposes such as noise removal. In other words, coil components in electronic devices may be used as power inductors, HF inductors, general beads, GHz beads, common mode filters, or the like.

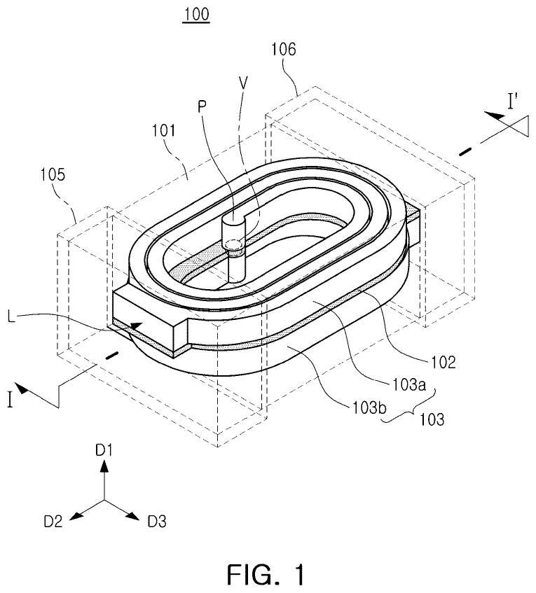

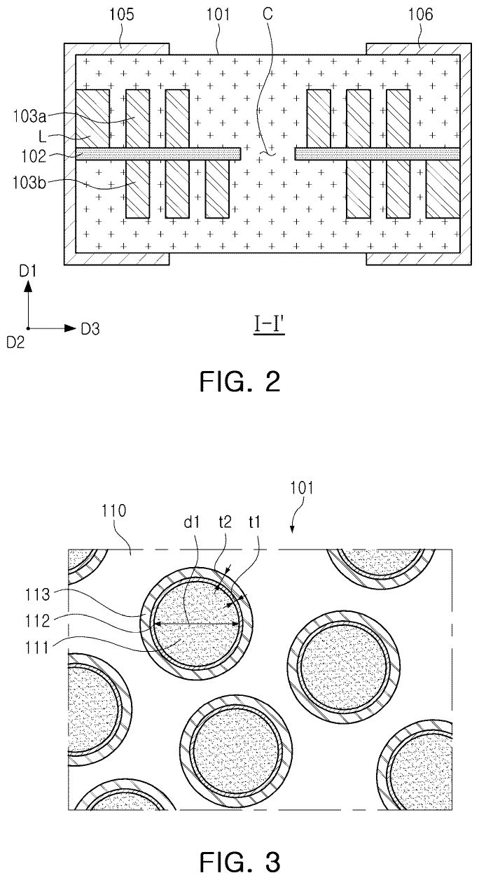

FIG. 1 is a schematic transparent perspective view illustrating a magnetic component according to an embodiment of the present disclosure. FIG. 2 is a cross-sectional view of a region of the magnetic component of FIG. 1. FIG. 3 is an enlarged view of a region of a magnetic body in the magnetic component of FIG. 1.

Referring to FIGS. 1 to 3, a magnetic component 100 according to the present embodiment may include a magnetic body 101 including a plurality of magnetic particles 111, and, in this case, at least a portion of magnetic particles 111, among the plurality of magnetic particles 111, may include a first layer 112 disposed on a surface, and a second layer 113 disposed on a surface of the first layer 112. In terms of material, the first layer 112 may include an Fe oxide component, and an average thickness t1 thereof may be less than 5 nm. Additionally, the second layer 113 may include an Si oxide component, and an average thickness t2 thereof may be 5 nm or more. By having this coating structure, a volume fraction occupied by an Fe oxide layer within the magnetic particles 111 may be reduced, thereby minimizing a decrease in magnetic permeability characteristics of the magnetic particles 111, and further improving insulating properties of the magnetic particles 111. Hereinafter, main components constituting the magnetic component 100 of the present embodiment will be described.

The magnetic body 101 may form an exterior of the magnetic component 100, and a coil 103 and a support member 102 supporting the coil 103 may be disposed inside the magnetic body 101. As illustrated in FIG. 3, the magnetic particles 111 may be dispersed inside of an insulating material 110. The insulating material 110 may include a dispersant, a binder, etc., and may include a polymer component such as an epoxy resin, polyimide, or the like. The magnetic body 101 may be formed to have a hexahedral shape. As an example, in the magnetic component 100 according to the present embodiment in which external electrodes 105 and 106 are formed, the magnetic body 101 may be formed to have a length of 2.5 mm, a width of 2.0 mm, and a thickness of 1.0 mm, a length of 2.0 mm, a width of 1.2 mm, and a thickness of 0.65 mm, a length of 1.6 mm, a width of 0.8 mm, and a thickness of 0.8 mm, a length of 1.0 mm, a width of 0.5 mm, and a thickness of 0.5 mm, or a length of 0.8 mm, a width of 0.4 mm, and a thickness of 0.65 mm, but the present disclosure is not limited thereto. Since the above-mentioned values are merely design values that do not reflect process errors, etc., a range that may be recognized as a process error should be considered to fall within the scope of the present disclosure.

A length of the above-described magnetic component 100 in the first direction D1 may mean, based on an optical microscope image or a scanning electron microscope (SEM) image of a first direction D1-third direction D3 cross-section taken from a central portion of the magnetic component 100 in the second direction D2, the maximum value among dimensions of each of a plurality of line segments, connecting two outermost boundary lines of the magnetic component 100 disposed in the first direction D1, illustrated in the image, and parallel to the first direction D1, the minimum value among dimensions of each of a plurality of line segments, connecting two outermost boundary lines of the magnetic component 100 disposed in the first direction D1, illustrated in the image, and parallel to the first direction D1, or an arithmetic mean value of at least three of values of each of a plurality of line segments, connecting two outermost boundary lines of the magnetic component 100 disposed in the first direction D1, illustrated in the image, and parallel to the first direction D1. In this case, the plurality of line segments parallel to the first direction D1 may be equally spaced apart from each other in the third direction D3, but the scope of the present disclosure is not limited thereto.

A length of the above-described magnetic component 100 in the second direction D2 may mean, based on an optical microscope image or a scanning electron microscope (SEM) image of a first direction D1-second direction D2 cross-section taken from a central portion of the magnetic component 100 in the third direction D3, the maximum value among dimensions of each of a plurality of line segments, connecting two outermost boundary lines of the magnetic component 100 disposed in the second direction D2, illustrated in the image, and parallel to the second direction D2, the minimum value among dimensions of each of a plurality of line segments, connecting two outermost boundary lines of the magnetic component 100 disposed in the second direction D2, illustrated in the image, and parallel to the second direction D2, or an arithmetic mean value of at least three of values of each of a plurality of line segments, connecting two outermost boundary lines of the magnetic component 100 disposed in the second direction D2, illustrated in the image, and parallel to the second direction D2. In this case, the plurality of line segments parallel to the second direction D2 may be equally spaced apart from each other in the first direction D1, but the scope of the present disclosure is not limited thereto.

A length of the above-described magnetic component 100 in the third direction D3 may mean, based on an optical microscope image or a scanning electron microscope (SEM) image of a first direction D1-third direction D3 cross-section taken from a central portion of the magnetic component 100 in the second direction D2, the maximum value among dimensions of each of a plurality of line segments, connecting two outermost boundary lines of the magnetic component 100 disposed in the third direction D3, illustrated in the image, and parallel to the third direction D3, the minimum value among dimensions of each of a plurality of line segments, connecting two outermost boundary lines of the magnetic component 100 disposed in the third direction D3, illustrated in the image, and parallel to the third direction D3, or an arithmetic mean value of at least three of values of each of a plurality of line segments, connecting two outermost boundary lines of the magnetic component 100 disposed in the third direction D3, illustrated in the image, and parallel to the third direction D3. In this case, the plurality of line segments parallel to the third direction D3 may be equally spaced apart from each other in the first direction D1, but the scope of the present disclosure is not limited thereto.

Each of the lengths of the magnetic component 100 in the first to third directions D1 to D3 may be measured using a micrometer measurement method. The micrometer measurement method may be measured by setting a zero point with a micrometer with Gage Repeatability and Reproducibility (R&R), inserting the magnetic component 100 according to the present embodiment between tips of the micrometer, and turning a measuring lever of the micrometer. In measuring a length of the magnetic component 100 using the micrometer measurement method, the length of the magnetic component 100 may mean a value measured once or an arithmetic average of values measured multiple times.

Referring to FIG. 3, the magnetic body 101 may include a plurality of magnetic particles 111 including an Fe-based alloy. When the magnetic particles 111 are implemented with an Fe-based alloy, magnetic properties such as saturation magnetization value may be excellent, but for purposes such as reducing eddy current loss or the like, at least a portion thereamong may include a first layer 112 disposed on a surface, and a second layer 113 disposed on a surface of the first layer 112. The plurality of magnetic particles 111 may have an average diameter d1 of about 10 to 25 μm. In the present embodiment, the Fe-based alloy included in the magnetic 111 may include an Fe—Si—B—C-based material. More specifically, the Fe-based alloy may not include Cr, Mo, Nb, and P components. These elements may be ingredients to strengthen corrosion resistance by slowing down corrosion progress of the magnetic particles 111. When an amount thereof increases, an Fe amount therein relatively decreases, which may lower saturation magnetization values of the magnetic particles 111. In the present embodiment, an Fe-based alloy including a relatively large amount of Fe may be used to ensure sufficient saturation magnetization characteristics, and even in this case, the first layer 112 corresponding to a surface oxide film may be formed very thin such that the magnetic particles 111 are allowed to exist in a sufficient volume fraction within the magnetic body 101. The magnetic particles 111 and an insulating structure (the first layer and the second layer) will be described in more detail later.

Regarding an example of a manufacturing method, the magnetic body 101 may be formed using a lamination method. Specifically, after forming a coil 103 on a support member 102 using a process such as plating or the like, a plurality of unit stacks for manufacturing the magnetic body 101 may be prepared and stacked. In this case, the unit stacks may be prepared as sheet types by mixing a magnetic particle 111, such as a metal or the like, and an organic material such as a thermosetting resin, a binder, a solvent, or the like, to form a slurry, applying the slurry to a carrier film by a doctor blade method, to a thickness of several tens of μm, and drying the same. Therefore, the unit stacks may be manufactured in a form in which the magnetic particle is dispersed in the thermosetting resin such as an epoxy resin, polyimide, or the like. The magnetic particles 111 may have the configuration described above, and the first layer 112 and the second layer 113 may be disposed on surfaces thereof. The magnetic body 101 may be implemented by forming a plurality of the above-described unit stacks and pressurizing the same on upper and lower portions of the coil 103.

The support member 102 may support the coil 103, and may be formed of polypropylene glycol (PPG), ferrite, a metallic soft magnetic member, or the like. As illustrated, a central portion of the support member 102 may be penetrated to form a through-hole, and the through-hole may be filled with the magnetic body 101 to form a magnetic core portion C.

The coil 103 may be disposed inside the magnetic body 101, and may perform various functions in an electronic device. For example, the magnetic component 100 may be a power inductor, and in this case, the coil 103 may store electricity in the form of a magnetic field to maintain an output voltage to stabilize a power source. In this case, coils 103 may be stacked on both surfaces of the support member 102, and may be electrically connected through a conductive via V penetrating the support member 102. The coil 103 may be formed in a spiral shape, and a lead-out portion T exposed outside of the magnetic body 101 may be included in an outermost portion of this spiral shape, for electrical connection with the external electrodes 105 and 106.

The coil 103 may be disposed on at least one of a first surface (an upper surface in FIG. 2) or a second surface (a lower surface in FIG. 2), opposing each other, in the support member 102. As in the present embodiment, a first coil 103a and a second coil 103b may be disposed on the first and second surfaces of the support member 102, respectively. In this case, the coil 103 may include a pad P. Unlike this, the coil 103 may be disposed on only one surface of the support member 102. A coil pattern forming the coil 103 may be formed using a plating process used in the art, such as pattern plating, anisotropic plating, isotropic plating, or the like, and may be formed as a multi-layer structure using a plurality of processes among these processes.

The external electrodes 105 and 106 may be formed outside of the magnetic body 101, to be connected to the lead-out portion T. The external electrodes 105 and 106 may be formed using a paste containing metal having excellent electrical conductivity, and the paste may be, for example, a conductive paste containing nickel (Ni), copper (Cu), tin (Sn), or silver (Ag), alone or as an alloy thereof, or the like. Additionally, a plating layer may be formed on the external electrodes 105 and 106. In this case, the plating layer may include one or more selected from the group consisting of nickel (Ni), copper (Cu), and tin (Sn), and, for example, a nickel (Ni) layer and a tin (Sn) layer may be formed sequentially. In FIG. 1, the external electrodes 105 and 106 may have a shape extending from one side surface of the magnetic body 101 to upper and lower surfaces and side surface, but may be implemented in various other shapes, and may have, for example, an L-shape.

To describe the plurality of magnetic particles 111 included in the magnetic body 101 in more detail, an Fe amount in the Fe-based alloy included in the magnetic particles 111 may relatively large, and may exceed, for example, 90 wt %. As the Fe amount increases in the Fe-based alloy, any one of chromium (Cr), molybdenum (Mo), niobium (Nb), or phosphorus (P) may not be added, and neither of these components may be added. For more specific composition conditions, an Si amount in the Fe-based alloy may be 0.1 to 5 wt %. Additionally, a boron (B) amount in the Fe-based alloy may be 0.1 to 5 wt %. Additionally, a carbon (C) amount in the Fe-based alloy may be 0.1 to 2 wt %.

An average diameter d1 of the magnetic particles 111 may be 10 to 25 μm, and measurement of the diameter d1 may be performed, for example, from an image of a cross-section of the magnetic body 101. As a specific example, after imaging a plurality of equally spaced regions (e.g., 10 regions) in the D2 direction or the like with respect to a D1-D3 cross-section passing through a center of the magnetic body 101 with a scanning electron microscope, the diameter d1 of the magnetic particles 111 may be obtained using an analysis program. In this case, due to a compression process or the like, a region near an exterior surface of the magnetic body 101 may be deformed, or the first layer 112 and the second layer 113 of the particles therein may be destroyed. Therefore, the magnetic particles 111 may be excluded and the diameter d1 may be measured. For example, a region corresponding to a distance within 5% or 10% from a surface of the magnetic body 101 may be excluded for such measurements.

In the magnetic particles 111 in which saturation magnetization characteristics are enhanced, the Fe-based alloy included therein may not include a corrosion resistance enhancing element, and a thick oxide film may be formed on a surface due to a decrease in corrosion resistance. The oxide film may correspond to a surface oxide film or a natural oxide film in which a surface of a magnetic particle 111 is oxidized, and a structure thereof may not be dense, moisture and oxygen may thus continue to penetrate the oxide film. The oxide film may have a secondary phase form of an Fe oxide, and when the oxide film becomes too thick, magnetic properties of the magnetic body 101, such as magnetic permeability, may be lowered. In the present embodiment, an average thickness t1 of the first layer 112 corresponding to the surface oxide layer may be thinned to a level of more than 0 nm and less than 5 nm, thereby reducing a proportion of the oxide layer in the magnetic particle 111, and from this, a decrease in magnetic permeability characteristics of the magnetic particles 111 may be minimized. As will be described later, when the average thickness t1 of the first layer 112 is implemented to be thinner than 5 nm, sufficient magnetic permeability may be secured.

The first layer 112 may be formed by oxidizing a surface of the magnetic particle 111, and thus may be formed directly on the surface of the magnetic particle 111. In this case, the thickness t1 of the first layer 112 may be defined as a distance from the surface of the magnetic particle 111 to the surface of the first layer 112, and may correspond to an average of thicknesses measured in a plurality of regions. The average thickness t1 of the first layer 112 may be obtained by acquiring an SEM or TEM image of at least one cross-section of the magnetic particle 111 and then measuring thicknesses of a plurality of regions at equal intervals. The first layer 112 may include at least one of an Fe—O-based material or an Fe—Si—O-based material. For example, the first layer 112 may include Fe₂O₃. Unlike the second layer 113, even when the first layer 112 includes an Fe—Si—O-based material, Si may be added in an extremely small amount. For example, the first layer 112 may include less than 1 wt % of a Si component. Additionally, the first layer 112 may be formed as an amorphous structure, and accordingly, when analyzing its presence or absence, the analysis may be performed by a composition rather than by a structure. When a thick natural oxide film is formed on a surface of the magnetic particle 111, crystallization may occur during heat treatment, and the oxide film may be reacted with the second layer 113 including the Si component to form a secondary phase, thereby reducing magnetic permeability and withstand voltage characteristics.

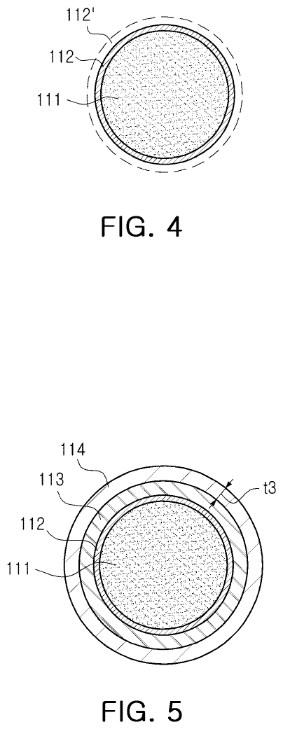

FIG. 4 illustrates how a thickness of a surface insulating layer in a magnetic particle is reduced. Referring to FIG. 4, a first layer 112 may be initially formed as a thick film layer 112′ on a surface of a magnetic particle 111, and then a thickness thereof may be reduced by a separate etching process. As described above, a surface oxide film of the thick film layer 112′ may be formed thicker (e.g., 20 nm or more), when no corrosion resistance element is added to an Fe-based alloy, which may adversely affect magnetic properties of a magnetic component 100. In the present embodiment, the thick film layer 112′ may be etched to reduce a thickness thereof such that an average thickness t1 of the first layer 112 may be less than 5 nm. As will be described later, when the average thickness t1 of the first layer 112 is less than 5 nm and an average thickness t2 of a second layer 113 is 5 nm or more, magnetic permeability may be sufficiently secured and excellent withstand voltage characteristics may be maintained.

The second layer 113 of a multilayer insulating structure of the present embodiment may be provided to ensure more stable insulating characteristics, and may have an average thickness t2 of 5 nm or more. An upper limit of the average thickness t2 of the second layer 113 may be determined within a range in which magnetic properties such as magnetic permeability or the like is not significantly reduced. As an example, the average thickness t2 may be less than 50 nm. The thickness t2 of the second layer 113 may be defined as a distance from the surface of the first layer 112 to the surface of the second layer 113, and may be an average thickness of thicknesses measured in a plurality of regions. The average thickness t2 of the second layer 113 may be obtained by acquiring an SEM or TEM image of at least one cross-section of the magnetic particle 111 and then measuring thicknesses of a plurality of regions at equal intervals. The average thickness t2 of the second layer 113 may be thicker than the average thickness t1 of the first layer 112, and may be 2 to 10 times the average thickness t1 of the first layer 112.

The second layer 113 may include an Si oxide component, and may include, for example, SiO₂. In this case, the second layer 113 may include Si in a range from 30 wt % to 70 wt %. As the second layer 113 includes an Si oxide such as SiO₂, insulating properties of the second layer 113 may be further improved and the second layer 113 may have a uniform thickness. In insulation coating materials, based on an Sn oxide and a P oxide, commonly used in the past, there may be problems in which uniformity of thickness of a coating layer is low and withstand voltage characteristics are insufficient. As in the present embodiment, insulating properties of the magnetic particles 111 may be improved by the second layer 113 including the Si oxide, and further, a saturation magnetization delay effect may be achieved. In addition, as an additional effect, the second layer 113 may have a strong bonding force with the insulating material 110 included in the magnetic body 101. Therefore, high temperature and high humidity reliability may be improved. The second layer 113 may have further improved effects in terms of characteristics such as improved withstand voltage when the average diameter d1 of the magnetic particles 111 is relatively large in a range of 10 to 25 μm, as in the present embodiment. As an example of a method for forming the second layer 113, a liquid coating method may be used. For example, the liquid coating method using tetraethyl orthosilicate (TEOS) may be used, and the second layer 113 may be uniformly coated in a range of several tens of nanometers by hydrolysis using aqueous ammonia as a catalyst.

In the above-mentioned example, a method of using SEM or TEM images is illustrated in measuring the thicknesses t1 and t2 of the first layer 112 and the second layer 113, but in addition, the thickness may be measured by TEM-EDS analysis. Specifically, after polishing a sample of a magnetic component 100, cross-sections of magnetic particles 111 present in a magnetic body 101 were observed using an SEM, and samples near surfaces of the magnetic particles 111 were collected using a focused ion beam (FIB), and the magnetic particles 111 and insulating structures on the surfaces thereof may be observed under conditions of a STEM magnification of ×110K or higher and an acceleration voltage of 200 kV. The magnetic particles and the insulating structures on the surfaces thereof were observed under the conditions of a STEM magnification of ×110K or higher and an acceleration voltage of 200 kV. From this, an EDS line profile scan may be performed from near the surface of the magnetic particle 111 to the insulating structure (first and second layers), and a first layer 112 may be defined as a region ranging from a portion in which an amount of an Si component decreases rapidly to a portion in which an amount of an Fe component decreases rapidly. A second layer 113 may be defined as a region ranging from a portion in which an amount of the Si component increases rapidly to a portion in which an amount of the Si component decreases rapidly.

The inventors of the present disclosure prepared samples with different average thicknesses t1 and t2 of the first layer 112 and the second layer 113 and measured magnetic permeability and withstand voltage characteristics thereof. The magnetic permeability and withstand voltage characteristics were measured by manufacturing a powder core, and standards for defects were presented by converting the magnetic permeability according to a powder particle size. As for the withstand voltage characteristics, samples with a breakdown voltage greater than 100 V/mm were labeled “O” and samples with a breakdown voltage less than 100 V/mm were labeled “X”.

TABLE 1

| | Average | Average | | | |
|---|---|---|---|---|---|
| | Thickness | Thickness | | | Withstand |
| | of First | of Second | | Magnetic | Voltage |
| | Layer A | Layer B | | Perme- | Character- |
| | (nm) | (nm) | A/B | ability | istics |
| #1 | <5 | <5 | 0.6 | 28 | X |
| #2 | <5 | <10 | 0.6 | 27.5 | ◯ |
| #3 | <5 | 10 < B < 20 | 0.35 | 27 | ◯ |
| #4 | <5 | 20 < B < 30 | 0.2 | 26 | ◯ |
| #5 | <5 | 30 < B < 50 | 0.125 | 24 | ◯ |
| #6 | 5 < A < 10 | 10 < B < 20 | 0.5 | 23 | X |
| #7 | 5 < A < 10 | 20 < B < 30 | 0.28 | 22 | X |
| #8 | 10 < A < 30 | <5 | 4 | 24 | X |
| #9 | 10 < A < 30 | <10 | 2 | 23.5 | X |
| #10 | 10 < A < 30 | 10 < B < 20 | 1.34 | 22.8 | X |
| #11 | 10 < A < 30 | 20 < B < 30 | 0.8 | 22.3 | X |
| #12 | 10 < A < 30 | 30 < B < 50 | 0.5 | 21 | X |

According to the above experimental results, when the average thickness t1 of the first layer 112 is less than 5 nm and the average thickness t2 of the second layer 113 is 5 nm or more, it can be seen that sufficient magnetic permeability is obtained while also satisfying the withstand voltage characteristics.

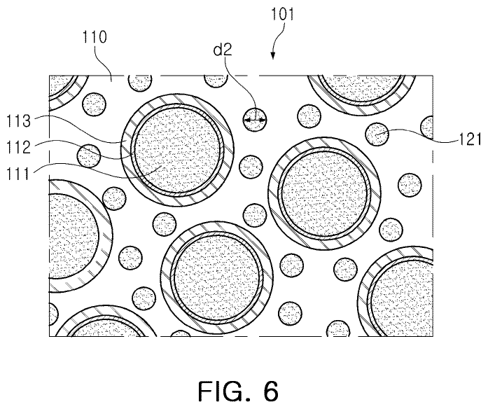

Hereinafter, modified examples illustrated in FIGS. 5 and 6 will be described. First, in the modified example of FIG. 5, an additional coating layer may be formed on a surface of a magnetic particle 111. Specifically, the magnetic particle 111 may further include a third layer 114 formed on a surface of a second layer 113, and, in this case, the third layer 114 may be a surface treatment layer obtained by performing surface treatment on the second layer 113. Due to the third layer 114 as a surface treatment layer, the magnetic particles 111 may have a hydrophobic surface and bonding force with an insulating material 110 of a magnetic body 101 may increase, thereby improving reliability of a magnetic component 100. As a surface treatment agent for the second layer 113 of the magnetic particle 111, a material having excellent bonding force with the second layer 113 and the insulating material 110 may be used. For example, at least one of oleic acid or a silane coupling agent may be used, and here, a urethane-based silane coupling agent may be used as the silane coupling agent.

The third layer 114 may include at least one functional group selected from the group consisting of an alkyl group, a carbonyl group, and urethane acrylate. In this case, the functional group included in the third layer 123 may be detected using a Fourier-transform infrared spectroscopy (FT-IR). When employing the third layer 114, which may be a surface treatment layer, the magnetic body 101 may include at least one ingredient of oleic acid, a derivative of oleic acid, or carbonic acid monoamide n-allyl neopentyl ester. In this case, the derivative of oleic acid may include at least one of oleic acid methyl ester, butyl oleate, or oleic acid 3-hydroxypropyl ester. The components included in the magnetic body 101 may be detected by gas chromatography-mass spectrometry (GC-MS). As described above, the third layer 114 may function to improve bonding force with the insulating material 110 within the magnetic body 101. When the third layer 114 is too thick, magnetic permeability of the magnetic body 101 may be likely to decrease. Therefore, an average thickness t3 thereof may be less than 10 nm.

Next, in the modified example of FIG. 6, a magnetic body 101 may have a configuration in which a magnetic particle 121 having a relatively small size is added, and may have a configuration in which a packing ratio of magnetic particles 111 and 121 in the magnetic body 101 increase. Specifically, the magnetic body 101 may further include an additional magnetic particle 121 having an average diameter d2, smaller than an average diameter of the magnetic particle 111 including a first layer 112 and a second layer 113, additional magnetic particles 121 may fill a space between magnetic particles 111 to increase a total amount of magnetic material present in the magnetic body 101. In this case, the average diameter d2 of the additional magnetic particles 121 may be 5 μm or less. The additional magnetic particles 121 may be formed of pure iron, and may be provided, for example, as carbonyl iron particles (CIP). In this case, a coating layer including the first layer 112 and the second layer 113 may not be formed on a surface of the additional magnetic particle 121.

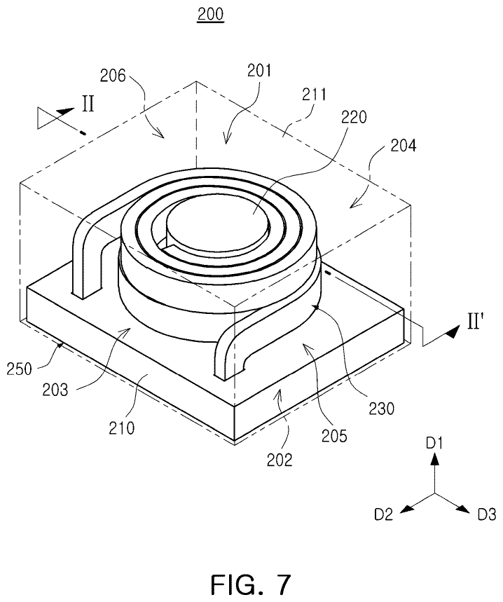

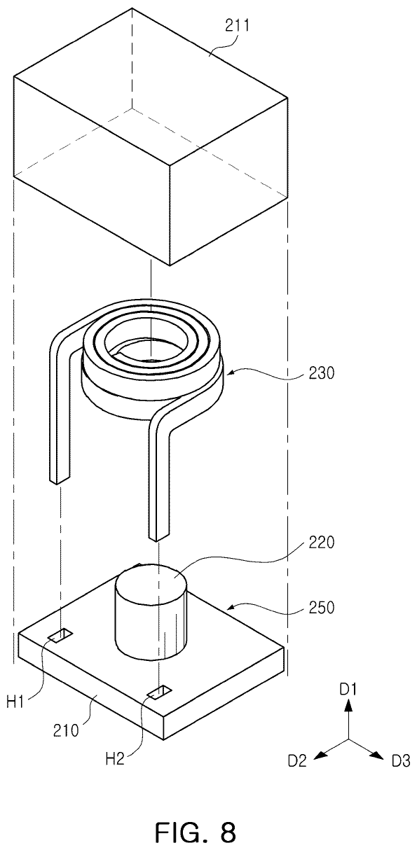

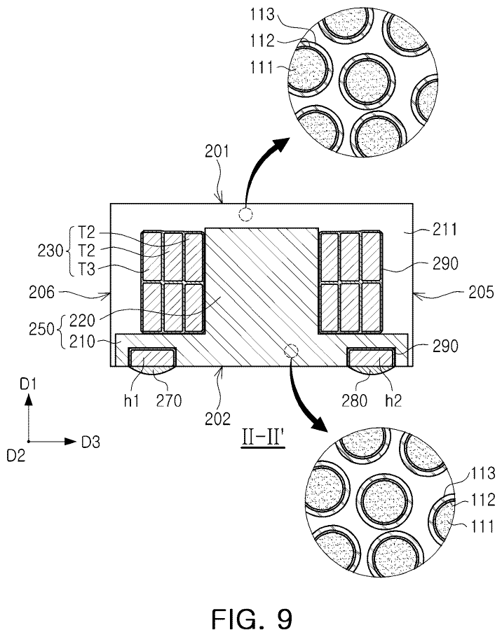

Another embodiment of the present disclosure will be described with reference to FIGS. 7 to 9. In the previous embodiment, a coil 103 and a support member 102 supporting the coil 103 may be disposed in a magnetic body 101, whereas the embodiments of FIGS. 7 to 9 may use a wound coil. To explain this, a magnetic component 200 may include a mold portion 250, a coil 230, a cover portion 211, and receiving grooves h1 and h2, and may further include external electrodes 270 and 280. A magnetic body may form an exterior of the magnetic component 200, and the coil 230 may be encapsulated therein. The magnetic body may include the mold portion 250 and the cover portion 211. The mold portion 250 may include a core 220. The magnetic body may be formed as a whole to have a hexahedral shape. The magnetic body may have a first surface 201 and a second surface 202, opposite to each other in the first direction D1, a third surface 203 and a fourth surface 204, opposite to each other in the second direction D2, and a fifth surface 205 and a sixth surface 206, opposite to each other in the third direction D3. The third to sixth surfaces 203 to 206 of the magnetic body may correspond to wall surfaces of the magnetic body connecting the first surface 201 and the second surface 202 of the magnetic body.

The magnetic body may be, for example, configured such that the magnetic component 200 according to the present embodiment on which the external electrodes 270 and 280, which will be described later, are formed has a length of 2.0 mm, a width of 1.2 mm, and a thickness of 0.6 mm, but the present disclosure is not limited thereto. The magnetic body may include the mold portion 250 and the cover portion 211. The cover portion 211 may be disposed on an upper portion of the mold portion 250, and may surround all surfaces except a lower surface of the mold portion 250. The mold portion 250 may have one surface and the other surface, opposite to each other. The one surface of the mold portion 250 may correspond to the lower surface of the mold portion 250, and may mean a region in which the receiving grooves h1 and h2, which will be described later, are disposed. As will be described later, since the receiving grooves h1 and h2 may be machined inside the mold portion 250, lower surfaces of the receiving grooves h1 and h2 may be disposed in a region between the one surface and the other surface of the mold portion 250. The mold portion 250 may include a support portion 210 and a core 220. The core 220 may be disposed in a central portion of the other surface of the support portion 210 in a manner that penetrates the coil 230. The mold portion 250 may be formed by filling a mold with a composite material including magnetic particles such as, for example, magnetic particles 111 including the first and second layers 112 and 113, and an insulating resin. In this case, the insulating resin may include epoxy, polyimide, a liquid crystal polymer, or the like, alone or in combination, but the present disclosure is not limited thereto.

The coil 230 may be encapsulated in the magnetic body to exhibit characteristics of the magnetic component 200. For example, when the magnetic component 200 of the present embodiment is used as a power inductor, the coil 230 may play a role in stabilizing power of an electronic device by storing an electric field as a magnetic field and maintaining an output voltage. The coil 230 may be disposed on the other surface of the mold portion 250. Specifically, the coil 230 may be wound around the core 220, and may be disposed on the other surface of the support portion 210. The coil 230 may be an air-core coil, and may be provided as a square coil. The coil 230 may be formed by winding a metal wire such as a copper wire or the like of which surface is covered with an insulating material in a spiral shape. The coil 230 may be provided as a plurality of layers. Each of the layers of the coil 230 may be formed in a planar spiral shape, and may have a plurality of turns. For example, the coil 230 may form an innermost turn T1, at least one middle turn T2, and an outermost turn T3 from a central portion of one surface of the mold portion 250 in an outward direction.

The cover portion 211 may be disposed on the mold portion 250 and the coil 230. The cover portion 211 may cover the mold portion 250 and the coil 230. The cover portion 211 may be disposed on the support portion 210, the core 220, and the coil 230 of the mold portion 250, and may be then pressurized to be coupled to the mold portion 250. The mold portion 250 and the cover portion 211 may include magnetic particles 111, respectively, and, in this case, the magnetic particles 111 may include a first layer 112 and a second layer 113, formed on a surface, as described above.

First and second receiving grooves h1 and h2 may be formed on one surface of the mold portion 250, to be spaced apart from each other, and both end portions of the coil 230, which will be described later, may be disposed in the first and second receiving grooves h1 and h2. For example, the first and second receiving grooves h1 and h2 may be respectively formed on the one surface of the mold portion 250, and may be spaced apart from each other, in a longitudinal direction (X). The first and second receiving grooves h1 and h2 may be disposed outside of a region corresponding to the core 220 on the one surface of the mold portion 250, but the present disclosure is not limited thereto. Each of the first and second receiving grooves h1 and h2 may be formed to extend on the one surface of the mold portion 250 in one direction, but may be formed in any shape not limited as long as it has a structure effectively exposing both end portions of the coil 230.

Since the magnetic body may be a region including the mold portion 250 and the cover portion 211, one surface of the magnetic body may mean one surface of the region including the mold portion 250 and the cover portion 211. The coil 230 may be drawn out externally, and may include first and second lead-out portions disposed in the first and second receiving grooves h1 and h2, respectively. The first and second receiving grooves h1 and h2 may be regions in which both end portions of the coil 230 are drawn out to the external electrodes 270 and 280, and may be thus spaced apart from each other to correspond to the first and second external electrodes 270 and 280, respectively, and may be formed on one surface of the magnetic body.

As an example, through-grooves H1 and H2 may be formed by a mold, when forming the mold portion 250, and the first and second receiving grooves h1 and h2 may be formed on the mold portion 250 by stacking and compressing magnetic sheets including metal magnetic particles, during a process of forming the cover portion 211. Protrusions corresponding to the through-grooves H1 and H2 may be formed in a mold for forming the mold portion 250, and the through-grooves H1 and H2 may be formed in the mold portion 250, which may be manufactured to have a shape corresponding to a shape of the mold. In addition, the first and second receiving grooves h1 and h2 may not be formed in a process for forming the mold portion 250, but may be formed in a process for forming the cover portion 211 on the mold portion 250. For example, both end portions of the coil 230 protruding from one surface of the mold portion 250 through the through-grooves H1 and H2 of the mold portion 250 may be buried inside the mold portion 250 in a process for pressing the magnetic sheet process. Because of this, the first and second receiving grooves h1 and h2 may be formed on the one surface of the mold portion 250. Alternatively, the first and second receiving grooves h1 and h2 and the through-grooves H1 and H2 may be formed in a process of forming the mold portion 250 using a mold. In this case, protrusions corresponding to the first and second receiving grooves h1 and h2 and the through-grooves H1 and H2 may be formed in the mold used to form the mold portion 250.

Both end portions of the coil 230 may pass through the one surface of the mold portion 250, and may be disposed in the first and second receiving grooves h1 and h2, respectively. Since a shape in which the end portions of the coil 230 are disposed in the receiving grooves h1 and h2 may not be limited, widths of the first and second receiving grooves h1 and h2 may be the same as or different from widths of the through-grooves H1 and H2. Both end portions of the coil 230 may be exposed to the one surface of the mold portion 250, for example, to the second surface 202 of the magnetic body. Both end portions of the coil 230 exposed to the one surface of the mold portion 250 may be disposed in the first and second receiving grooves h1 and h2 formed to be spaced apart from each other on the second surface 202 of the magnetic body. Both end portions of the coil 230 may pass through the support portion 210 of the mold portion 250, and may be exposed to one surface of the support portion 210. Although not specifically illustrated, both end portions of the coil 230 may be the same as a thickness of the coil 230, and may thus protrude from the one surface of the support portion 210 by a distance corresponding to the thickness of the coil 230. since the protruded end portion may also be polished in a process of polishing an opening of a plating resist for forming the external electrodes 270 and 280, which will be described later, an end portion of the coil 230 exposed on one surface of the support portion 210 may be substantially smaller than the thickness of the coil 230.

The external electrodes 270 and 280 may be arranged to be spaced apart from each other on one surface of the magnetic body, for example, the second surface 202. Specifically, the external electrodes 270 and 280 may be arranged to be spaced apart from each other on one surface of the mold portion 250, and may be connected to both end portions of the coil 230 disposed in the first and second receiving grooves h1 and h2, respectively. Since both end portions of the coil 230 may be disposed along lower surfaces of the first and second receiving grooves h1 and h2, and the external electrodes 270 and 280 may be applied along both end portions of the coil 230, the external electrodes may be formed to correspond to shapes of the first and second receiving grooves h1 and h2. As an example, a conductive resin including conductive powder particles such as silver (Ag) or the like may be applied to the first and second receiving grooves h1 and h2, to form the external electrodes 270 and 280. The external electrodes 270 and 280 may be formed of a conductive material such as copper (Cu), aluminum (Al), silver (Ag), tin (Sn), gold (Au), nickel (Ni), lead (Pb), chromium (Cr), titanium (Ti), or an alloy thereof, but the present disclosure is not limited thereto. The external electrodes 270 and 280 may be formed as a single-layer or multiple layers.

The magnetic component 200 according to the present embodiment may further include an insulating layer 290 surrounding a surface of the coil 230. There may be no limit to a process of forming the insulating layer 290, but for example, the insulating layer 290 may be formed by chemical vapor deposition of a parylene resin or the like on a surface of the coil 230, and may be formed by known methods such as a screen printing process, exposure of a photo resist (PR), a process through development, a spray application process, a dipping process, or the like. The insulating layer 290 is not particularly limited as long as it may be formed as a thin film, but may be formed by including, for example, a photoresist (PR), an epoxy resin, or the like.

A magnetic component according to an example of the present disclosure may have excellent magnetic properties, such as a high level of magnetic permeability, saturation magnetic flux characteristics, and the like.

While example embodiments have been illustrated and described above, it will be apparent to those skilled in the art that modifications and variations could be made without departing from the scope of the present disclosure as defined by the appended claims.

What is claimed is:

1. A magnetic component comprising:
a magnetic body,
wherein the magnetic body includes a plurality of magnetic particles including an Fe-based alloy,
at least a subset of the plurality of magnetic particles includes a first layer disposed on surfaces of the at least a portion of magnetic particles and a second layer disposed on a surface of the first layer,
the first layer includes an Fe oxide component and has an average thickness of less than 5 nm, and
the second layer includes an Si oxide component and has an average thickness of 5 nm or more.

2. The magnetic component of claim 1, wherein the first layer comprises less than 1 wt % of an Si component.

3. The magnetic component of claim 2, wherein the second layer comprises 30 wt % to 70 wt % of an Si component.

4. The magnetic component of claim 1, wherein the average thickness of the second layer is less than 50 nm.

5. The magnetic component of claim 1, wherein the average thickness of the second layer is 2 to 10 times the average thickness of the first layer.

6. The magnetic component of claim 1, wherein an average diameter of the plurality of magnetic particles is 10 to 25 μm.

7. The magnetic component of claim 1, wherein the subset of the plurality of magnetic particles further comprise a third layer disposed on a surface of the second layer.

8. The magnetic component of claim 7, wherein the third layer comprises at least one functional group of an alkyl group, a carbonyl group, or urethane acrylate.

9. The magnetic component of claim 7, wherein the magnetic body comprises at least one of oleic acid, a derivative of oleic acid, and monoamide n-allyl neopentyl ester carbonate.

10. The magnetic component of claim 7, wherein an average thickness of the third layer is less than 10 nm.

11. The magnetic component of claim 1, wherein the Fe-based alloy comprises an Fe—Si—B—C-based material.

12. The magnetic component of claim 11, wherein the Fe-based alloy does not comprise Cr, Mo, Nb, and P components.

13. The magnetic component of claim 11, wherein an Fe amount in the Fe-based alloy exceeds 90 wt %.

14. The magnetic component of claim 13, wherein an Si amount in the Fe-based alloy is 0.1 to 5 wt %.

15. The magnetic component of claim 1, wherein the magnetic body further comprises additional magnetic particles having an average diameter, smaller than an average diameter of the plurality of magnetic particles including the first layer and the second layer.

16. The magnetic component of claim 15, wherein the additional magnetic particles comprise carbonyl iron particles.

17. Magnetic particles, comprising:
a core comprising an Fe-based alloy;
a first layer disposed on a surface of the core, comprising a Fe oxide component and having an average thickness of less than 5 nm; and
a second layer disposed on a surface of the first layer, comprising an Si oxide component and having an average 2 to 10 times greater than that of the first layer.

18. The magnetic particles of claim 17, wherein second layer has an average thickness of at least 5 nm.

19. The magnetic particles of claim 17, wherein the core has an average diameter in a range from 10 μm to 25 μm.

20. The magnetic particles of claim 17, further comprising a third layer disposed on a surface of the second layer and comprising at least one functional group of an alkyl group, a carbonyl group, or urethane acrylate.

21. The magnetic particles of claim 20, wherein an average thickness of the third layer is less than 10 nm.

22. The magnetic particles of claim 17, wherein the Fe-based alloy comprises an Fe—Si—B—C-based material and does not include Cr, Mo, Nb, and P components.

23. The magnetic particles of claim 17, wherein a content of Si in the first layer is less than 1 wt %, and a content of Si in the second layer is in a range from 30 wt to 70 wt.

24. A coil electronic component, comprising a coil wound around a magnetic core and encapsulated in a magnetic body, wherein at least a portion of the magnetic core and/or the magnetic body comprises magnetic particles of claim 17.
